(19) United States
(12) Patent Application Publication
(10) Pub. No.: US 2014/0299304 A1
(43) Pub. Date: Oct. 9, 2014

(54) Precision Tube Bead Design for an Aluminum Grommetted Tube Radiator Assembly

(71) Applicant: CATERPILLAR INC., Peoria, IL (US)

(72) Inventors: Sudhakara Reddy Gopireddy, Dunlap, IL (US); Neil Alan Terry, Edelstein, IL (US); Mahesh Kumar Mokire, Dunlap, IL (US); Sumeeth Sivanagere, Dunlap, IL (US)

(73) Assignee: Caterpillar Inc., Peoria, IL (US)

(21) Appl. No.: 13/859,287

(22) Filed: Apr. 9, 2013

(51) Int. Cl. F28F 1/12; B23P 15/26

(52) U.S. Cl. CPC F28F 1/12; B23P 15/26
USPC 165/181; 29/890.046

(57) ABSTRACT

An aluminum tube-and-fin assembly for easy insertion into a manifold seal is provided. The assembly comprises a generally cylindrical, elongated tube and fins extending radially outward from the body. A bead is formed circumferentially around the tube end. A smooth, curved, circumferentially disposed bead corner is interposed between the bead and the tube end. The bead corner has a frustoconical curved shape and a radii of curvature of at least 0.2 mm.

### TECHNICAL FIELD

This disclosure relates generally to tube-and-fin style heat exchangers. More particularly, this disclosure relates to a precision tube bead design for a tube-and-fin style assembly for use in an Aluminum Grommetted Tube radiator.

### BACKGROUND

Large heavy duty machines such as dozers, loaders and excavators require large radiators for engine cooling. One common radiator design is the tube-and-fin structure, where numerous tube-and-fin assemblies are mounted to upper and lower coolant manifolds and arranged in columns and rows. Copper Grommetted Tube (CGT) radiators, in which copper tube-and-fin assemblies are secured to coolant manifolds or other radiator components, are expensive, which has led to the development of Aluminum Grommetted Tube (AGT) radiators. Aluminum is less expensive than copper and lighter than copper, but is less malleable.

The tube-and-fin assemblies that make up a radiator are secured to the coolant manifolds and sealed thereto with flexible grommets or seals. The tubes may comprise a bead circumferentially disposed around a lower end of the tube, and the seals include a circumferential groove for receiving the bead to hold the tube-and-fin assembly in place. One such tube and seal construction is disclosed in U.S. Pat. No. 3,391,732 (“Radiator Construction”), which describes a tube (“conduit 25”) having a bead (“flange 36”) adapted to be received within a groove 33 in a grommet 30, the bead having “slightly larger dimensions.”

When a conventional copper tube-and-fin assembly is inserted into the seal, the seal flexes outwardly when the bead impinges on the top surface of the seal due to the larger diameter of the bead. In conventional systems, the top surface of the seal can be depressed inwardly during installation of the tube-and-fin assembly, making tube insertion difficult. Making the tube-and-fin assembly out of aluminum saves money, but because aluminum is less malleable than copper it can be more difficult to insert an aluminum tube-and-fin assembly into a manifold seal. The present disclosure is directed toward solving this problem.

### SUMMARY

In one aspect of the disclosure, an aluminum tube-and-fin assembly for an Aluminum Grommetted Tube radiator is provided. The assembly comprises a tube comprising a generally elliptical, cylindrical and elongated body defining an axis A. The elongated body may have flattened sides connected by rounded ends. The tube further comprises a generally cylindrical bottom end for attachment to a coolant manifold, and a bead formed circumferentially around the tube bottom end. The tube may further comprise a generally cylindrical top end. Fins extend radially outward from one or both sides of the tube body. A circumferentially disposed bead corner is located under the bead where the bead and the tube bottom end are joined. The bead corner has a radii of curvature of at least 0.2 mm. Preferably the bead and the tube are a single unitary structure.

In another aspect of the disclosure a method of installing onto a manifold a tube-and-fin assembly is provided. The tube-and fin assembly comprises a tube having a generally cylindrical bottom end, a bead formed circumferentially around and joined to the bottom end, and a circumferentially disposed frustoconical curved shaped bead corner located under the bead where the bead and the tube bottom end are joined. The manifold is provided with a header plate having openings in which a flexible seal has been inserted. The seal comprises a substantially cylindrical body, a flange portion extending outward from the body and having a top surface, and an inner wall defining a bore and a groove disposed circumferentially about the inner wall. The method comprises the steps of: (a) inserting the tube-and-fin assembly into the bore until the bead impinges on the top surface of the seal; (b) allowing the bead corner to cause the top surface to flare outwardly; and (c) pushing the tube-and-fin assembly into the bore until the bead is captured within the seal groove.

### BRIEF DESCRIPTION OF THE DRAWINGS

FIG. 1 is a perspective view of a tube-and-fin assembly for use in a radiator;

FIG. 2 is a partial perspective view of a portion of the tube-and-fin assembly of FIG. 1 shown with an unstressed seal;

FIG. 3 is a cross-sectional view of a tube-and-fin assembly being inserted into a manifold seal;

FIG. 4 is a cross-sectional view of a tube-and-fin assembly after being inserted into a manifold seal; and

FIG. 5 is a close up view of a portion of the tube-and-fin assembly of FIG. 2 illustrating the bead geometry in further detail.

### DETAILED DESCRIPTION

While this disclosure may be embodied in many forms, there is shown in the drawings and will herein be described in detail one or more embodiments with the understanding that this disclosure is to be considered an exemplification of the principles of the disclosure and is not intended to limit the disclosure to the illustrated embodiments.

In the description that follows, the term “radii of curvature” means the axial distance “R” between a top inflection plane P1 (where the curvature of the tube outer surface 13 changes from convex to concave when viewed in a longitudinal cross-section) and a bottom inflection plane P2 (where the outer surface 13 of the tube 12 changes from concave to flat or straight when viewed in a longitudinal cross-section). The radii of curvature is thus the axial distance R of the arced outer surface located under the bead 40 where the bead 40 merges into the cylindrical outer surface of the lower end 24 of the tube 12.

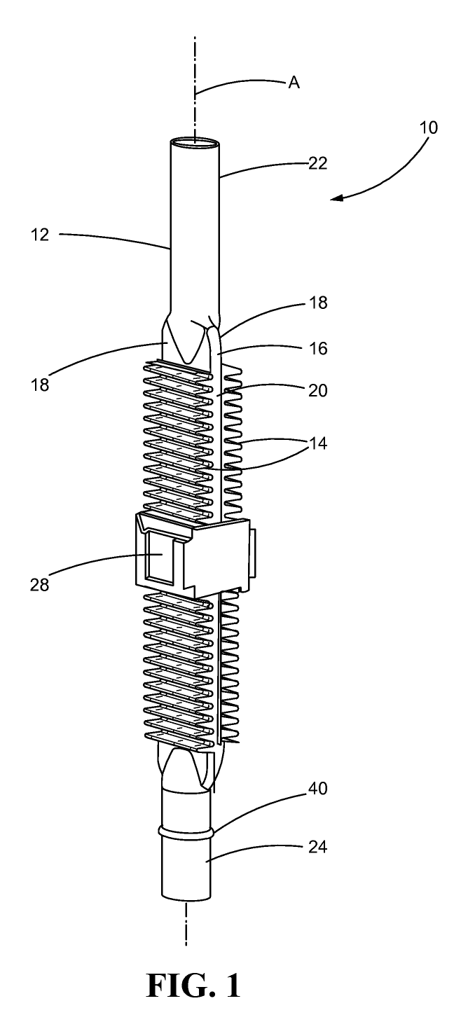

Turning to the drawings, there is shown in FIG. 1 a perspective view of a tube-and-fin assembly 10 of the kind used in a radiator for a large heavy duty vehicle. The assembly 10 comprises a tube 12 and a plurality of fins 14.

The tube 12 has an outer surface 13 and comprises a generally elliptical, cylindrical and elongated body 16 having flattened sides 18 connected by rounded ends 20 and defining a longitudinal axis A. The tube 12 may further comprise a generally cylindrical top end 22 and a generally cylindrical bottom end 24 for attachment to coolant manifolds. Each fin 14 extends radially outward from a side 18 of the body 16. As explained further below, the tube 12 is supported by a seal 30 at the top end 22 and at the bottom end 24.

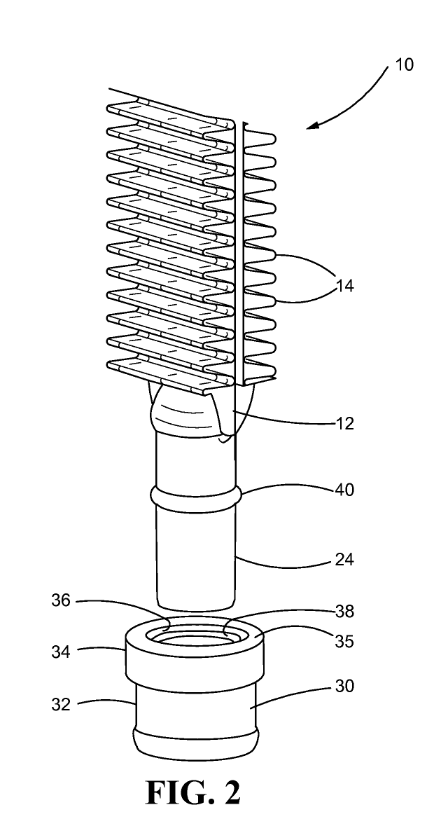

FIG. 2 is a partial perspective view of the bottom portion of the tube-and-fin assembly 10 of FIG. 1 shown with a grommet or seal 30. The seal 30 may be made of rubber or other flexible material. The seal 30 comprises a substantially cylindrical body 32, a flange portion 34 extending outward from the body 30 and having a top surface 35, and an inner wall 36 defining a bore. The inner wall 36 further defines a groove 38 disposed circumferentially about a portion of the inner wall 36 opposite the flange 34 and configured to receive a bead 40.

The bead 40 is formed circumferentially around the tube bottom end 24. The bead 40 may be integrally formed as part of an extruded tube 12 and is designed to help secure the tube 12 to a manifold by fitting within the groove 38 formed in the seal 30.

The tube-and-fin assemblies 10 generally are installed manually. Therefore easy installation of the tube-and-fin assemblies 10 can result in a significant savings of time and cost, and a lesser chance of damaging the tube-and-fin assemblies 10 and the seals 30.

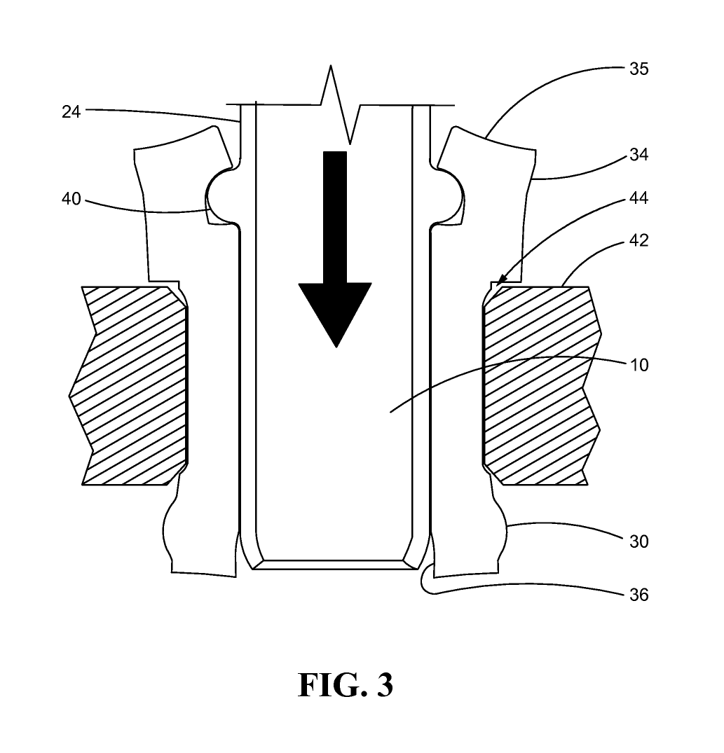

FIG. 3 is a cross-sectional view of a tube-and-fin assembly 10 being installed onto the header plate 42 of a manifold. The seal 30 generally fits within an opening 44 in the header plate 42. When the tube-and-fin assembly 10 is inserted into the seal 30, the seal 30 has to flex outwardly due to the larger diameter of the bead 40.

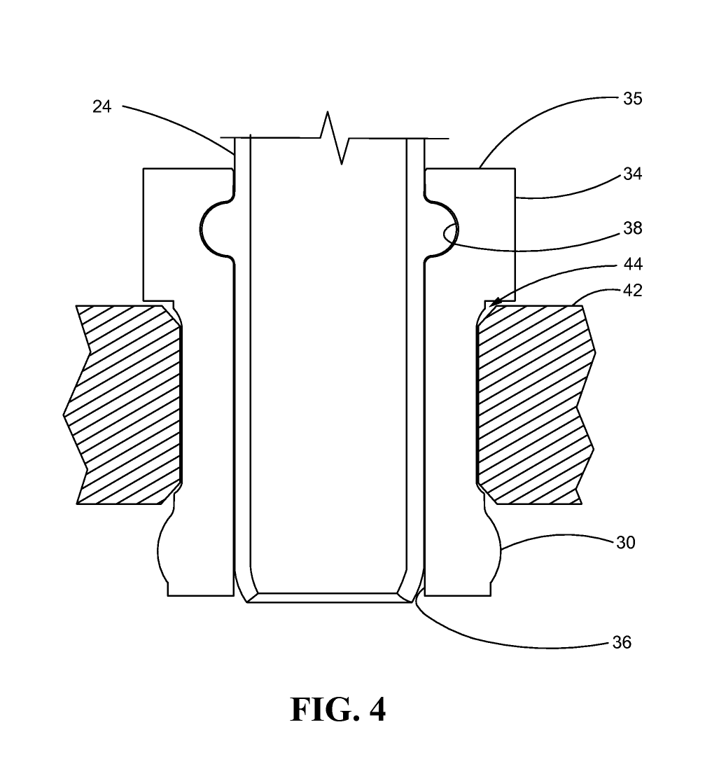

FIG. 4 is a cross-sectional view of a tube-and-fin assembly 10 after being installed in a manifold. The bead 40 is now locked into the groove 38 to minimize or eliminate motion of the tube-and-fin assembly 10 during operation of the vehicle.

When installing a tube-and-fin assembly 10 in a radiator, the top end of the tube 12 slides relatively easily into the seal located in the top header plate which forms part of the top manifold because there is no bead at the top end 22 of the tube 12. However, when trying to insert the bottom end 24 of the tube into a seal 30 located in the header plate 42 which forms part of the bottom manifold, due to the geometry of a conventional bead, the top surface 35 of the seal 30 can be depressed or deformed inwardly during insertion of the tube 12, making installation of the tube-and-fin assemblies 10 difficult.

The circumferential region under the bead 40 where the bead 40 and the cylindrical tube bottom end 24 are joined is referred to herein as the “bead corner”. In a conventional tube 12 the bead corner may be little more than a two dimensional ring or circle with little or no dimension in the axial direction. Thus a conventional bead corner has either no radii of curvature R or at best a very small radii of curvature R (less than 0.1 mm), which can prevent the outward flexing of the seal top surface 35 and thus make it difficult to push the bead into the seal groove. The present disclosure is directed toward solving this problem.

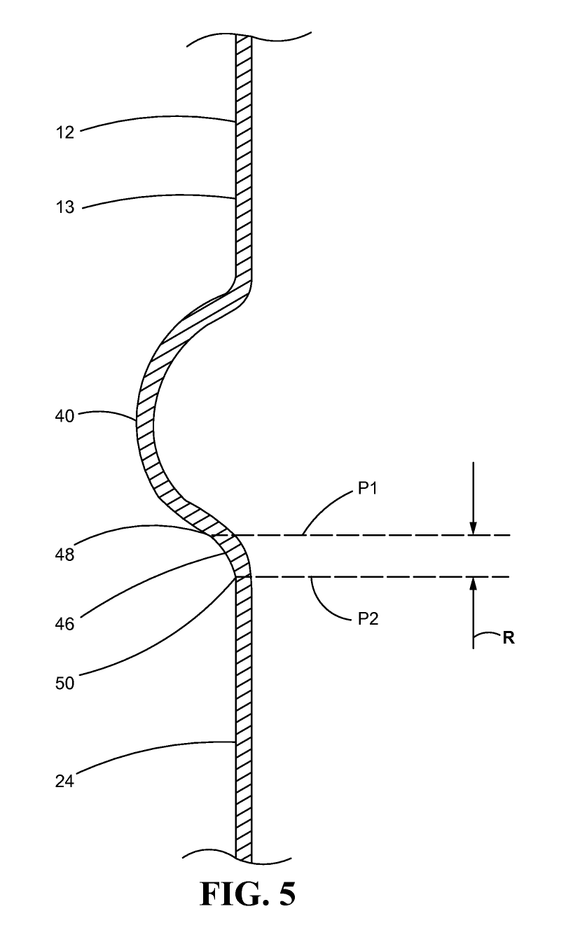

FIG. 5 is a close up view of a portion of a tube-and-fin assembly 10 according to the disclosure. In accordance with an aspect of the disclosure, the bead 40 includes a bead corner 46 having a smooth, generous radii of curvature R which serves to flare out the seal 30 when the bead 40 impinges on the top surface 35 of the seal 30 during insertion of the tube 12 into the seal 30. The bead corner 46 is a smooth, three-dimensional, circumferential, frustoconical curved shaped surface between the bead 40 and the cylindrical tube bottom end 24 where the bead 40 and the bottom end 24 are joined. (The term “frustoconical curved shaped surface” as used herein refers to a three-dimensional surface shaped like a truncated cone but with an inwardly curved surface.) The bead corner 46 extends from the bead 40 to the bottom end 24. In the two-dimensional cross-sectional view of FIG. 5, when viewed from outside the tube 12, the bead 40 is generally convex while the bead corner 46 is generally concave. The tube bottom end 24 appears flat or straight. Thus the bead corner 46 extends from a top inflection circle 48 (where the curvature of the tube exterior surface changes from convex to concave), to a bottom inflection circle 50 (wherein the surface of the tube 12 changes from concave to flat).

The minimum radii of curvature R of the bead corner 46, i.e., the vertical distance between the top and bottom inflection circles 48, 50 (or between the top and bottom inflection planes P1, P2), designated as “R” in FIG. 5, is about 0.2 mm. The operable radii of curvature R is about 0.2 mm to at least about 0.5 mm. The exterior surface of the tube 12 along the bead corner should be a smooth upside down bell shape.

As a result of this geometry, just before the bead 40 impinges on the top surface 35 of the seal 30, the bead corner 46 helps flare out the seal 30, thereby making easier insertion of the tube 12 into the seal 30.

In another aspect of the disclosure a method of installing onto a manifold a tube-and-fin assembly 10 of the type described herein is provided. The manifold is provided with a header plate 42 having openings in which seals 30 according to the disclosure have been inserted. The method comprises the steps of: (a) inserting the tube-and-fin assembly 10 into the bore of the seal 30 until the bead 40 impinges on the top surface 35 of the seal; (b) allowing the bead corner 46 to cause the top surface 35 to flare outwardly; and (c) pushing the tube-and-fin assembly 10 into the seal 30 until the bead 40 is locked or captured within the seal groove 38.

### INDUSTRIAL APPLICABILITY

The beaded tube-and-fin assembly of the present disclosure is easy to insert into a manifold seal without inwardly depressing the seal. The aluminum tube-and-fin assembly described herein may be used as a component of a radiator for use in a heavy duty vehicle, especially where cost and performance are design factors.

It is understood that the embodiments of the disclosure described above are only particular examples which serve to illustrate the principles of the disclosure. Modifications and alternative embodiments of the disclosure are contemplated which do not depart from the scope of the disclosure as defined by the foregoing teachings and appended claims. It is intended that the claims cover all such modifications and alternative embodiments that fall within their scope.

We claim:

1. A tube-and-fin assembly for a heat exchanger, the tube-and-fin assembly comprising:
a tube comprising a generally elliptical, cylindrical and elongated body defining a longitudinal axis, the tube further comprising a generally cylindrical first end for attachment to a coolant manifold;
a plurality of fins extending outward from at least a first side of the body;
a bead formed circumferentially around the first end; and
a circumferentially disposed bead corner interposed between the bead and the first end;
wherein the bead corner has a radii of curvature of at least 0.2 mm.

2. The tube-and-fin assembly of claim 1 wherein:
the bead corner has a radii of curvature of between about 0.2 mm and about 0.5 mm.

3. The tube-and-fin assembly of claim 1 wherein:
the elongated body has flattened sides connected by rounded ends.

4. The tube-and-fin assembly of claim 1 wherein:
the tube further comprises a generally cylindrical second end.

5. The tube-and-fin assembly of claim 1 wherein:
the bead and the tube are a single, unitary and indivisible structure.

6. The tube-and-fin assembly of claim 1 wherein:
the bead corner has a frustoconical curved shape.

7. The tube-and-fin assembly of claim 1 wherein:
the tube has an outer surface, a top inflection circle located under the bead where the curvature of the outer surface changes from convex to concave, and a bottom inflection circle located below the top inflection circle where the outer surface of the tube changes from concave to flat; and
the bead corner extends from the top inflection circle to the bottom inflection circle.

8. The tube-and-fin assembly of claim 1 wherein:
the tube has an outer surface and the tube defines a top inflection plane located under the bead where the curvature of the outer surface changes from convex to concave when viewed in a longitudinal cross-section and a bottom inflection plane located below the top inflection plane where the outer surface of the tube changes from concave to flat or straight when viewed in a longitudinal cross-section; and
the bead corner extends from the top inflection plane to the bottom inflection plane.

9. A method of installing onto a manifold a tube-and-fin assembly, the tube-and fin assembly comprising a tube having a generally cylindrical bottom end, a bead formed circumferentially around and joined to the bottom end, and a circumferentially disposed frustoconical curved shaped bead corner located under the bead where the bead and the tube bottom end are joined, the manifold provided with a header plate having openings in which a flexible seal has been inserted, the seal comprising a substantially cylindrical body, a flange portion extending outward from the body and having a top surface, and an inner wall defining a bore and a groove disposed circumferentially about the inner wall, the method comprising the steps of:
inserting the tube-and-fin assembly into the bore until the bead impinges on the top surface of the seal;
allowing the bead corner to cause the top surface to flare outwardly; and
pushing the tube-and-fin assembly into the bore until the bead is captured within the seal groove.

10. The method of claim 9 wherein:
the bead corner has a radii of curvature of between about 0.2 mm and about 0.5 mm.
